(19) United States
(12) Patent Application Publication
(10) Pub. No.: US 2026/0312511 A1
(43) Pub. Date: Oct. 8, 2026

(54) POWER SUPPLY CIRCUIT

(71) Applicant: FUJI ELECTRIC CO., LTD., Kawasaki-shi (JP)

(72) Inventor: Ryuji YAMADA, Tokyo (JP)

(73) Assignee: FUJI ELECTRIC CO., LTD., Kawasaki-shi (JP)

(21) Appl. No.: 19/463,797

(22) Filed: Jan. 29, 2026

(30) Foreign Application Priority Data
Mar. 5, 2025 (JP) 2025-034686

(51) Int. Cl. H02M 7/217; H02M 1/00; H02M 1/088; H02M 1/12; H02M 1/42; H02M 7/12

(52) U.S. Cl. CPC H02M 7/2176; H02M 1/0009; H02M 1/0043; H02M 1/088; H02M 1/123; H02M 1/4225; H02M 7/125

(57) ABSTRACT

A power supply circuit for generating an output voltage from an alternating current (AC) voltage. The power supply circuit includes: a full-wave rectifier circuit configured to rectify the AC voltage; first and second conductors configured to receive a voltage corresponding to the full-wave rectified voltage; first and second transistors configured to control first and second inductor currents flowing through the first and second inductors, respectively; a first common mode choke including a first coil connected between a positive-side output node of the full-wave rectifier circuit and the first inductor, and a second coil connected between a negative-side output node of the full-wave rectifier circuit and a low-potential-side electrode of the first transistor; first and second resistors configured to respectively detect the first and second inductor currents; and a switching control circuit configured to control switching of the first and second transistors, based on the detected first and second inductor currents.

### CROSS-REFERENCE TO RELATED APPLICATIONS

The present application claims priority pursuant to 35 U.S.C. §119 from Japanese patent application number 2025-034686, filed on Mar. 5, 2025, the entire disclosure of which is hereby incorporated by reference herein.

### BACKGROUND

### Technical Field

The present disclosure relates to a power supply circuit.

### Description of the Related Art

Power factor correction circuits include interleaved-type power factor correction circuits constituted by multiple circuit groups. Further, the power factor correction circuits include those operating in a critical mode of turning on a transistor in response to an inductor current reaching a predetermined value (for example, zero). When multiple circuit groups operate in an interleaved manner, an inductor current may not be accurately detected with resistors that are respectively provided to the respective ground lines of the multiple circuit groups. Thus, a transformer including a primary coil and an auxiliary coil may be used to detect that the inductor current flowing through the primary coil reaches a predetermined value using the voltage at the auxiliary coil (for example, Japanese Patent Application Publication Nos. 2021-044969, 2022-041912, 2023-003781, 2012-210145, and 2012-239269)

However, designing the transformer so as to respond to changes in the voltage level of the full-wave rectified voltage often becomes complex. Accordingly, it may be difficult to detect that the inductor current flowing through the primary coil reaches a predetermined value using the voltage at the auxiliary coil.

### SUMMARY

A first aspect of the present disclosure is a power supply circuit configured to generate an output voltage at a target level from an alternating current (AC) voltage inputted thereto, the power supply circuit comprising: a full-wave rectifier circuit configured to rectify the AC voltage and output a full-wave rectified voltage, the full-wave rectifier circuit having a positive-side output node and a negative-side output node; a first inductor and a second conductor that are configured to receive a voltage corresponding to the full-wave rectified voltage, each of the first inductor and the second conductor having a low-potential-side electrode; a first transistor configured to control a first inductor current flowing through the first inductor; a second transistor configured to control a second inductor current flowing through the second inductor; a first common mode choke including a first coil connected between the positive-side output node of the full-wave rectifier circuit and the first inductor, and a second coil connected between the negative-side output node of the full-wave rectifier circuit and the low-potential-side electrode of the first transistor; a first resistor configured to detect the first inductor current; a second resistor configured to detect the second inductor current; and a switching control circuit configured to control switching of the first transistor and the second transistor, based on the first inductor current detected by the first resistor, the second inductor current detected by the second resistor, and the output voltage.

A second aspect of the present disclosure is a power supply circuit configured to generate an output voltage at a target level from an alternating current (AC) voltage inputted thereto, the power supply circuit comprising: a full-wave rectifier circuit configured to rectify the AC voltage, and output a full-wave rectified voltage, the full-wave rectifier circuit having a positive-side output node and a negative-side output node; n inductors each configured to receive a voltage corresponding to the full-wave rectified voltage, the n being an integer of 3 or more; n transistors configured to respectively control inductor currents flowing through the n inductors; (n-1) common mode chokes each including a first coil connected between the positive-side output node of the full-wave rectifier circuit and each of (n-1) inductors, and a second coil connected between the negative-side output node of the full-wave rectifier circuit and each of low-potential-side electrodes of (n-1) transistors; n resistors configured to respectively detect the inductor currents flowing through the n inductors; and a switching control circuit configured to control switching of the n transistors, based on the inductor currents flowing through the n inductors detected by the n resistors, respectively, and the output voltage.

### BRIEF DESCRIPTION OF THE DRAWINGS

FIG. 1 is a diagram illustrating a configuration example of an AC-DC converter 10.

FIG. 2 is a diagram illustrating a configuration example of a power factor correction IC 27.

FIG. 3 is a diagram illustrating an example of the operation of a common mode choke 22a.

FIG. 4 is a diagram illustrating an example of the operation of a common mode choke 22a.

FIG. 5 is a diagram illustrating an example of the operation of a common mode choke 22a.

FIG. 6 is a diagram illustrating an example of each of currents Ipa, Ina, Inb, and Ipb.

FIG. 7 is a diagram illustrating simulation results.

FIG. 8 is a diagram illustrating a configuration example of an AC-DC converter 13.

FIG. 9 is a diagram illustrating an example of each of currents Ipa, Ina, Inb, and Ipb.

FIG. 10 is a diagram illustrating simulation results.

FIG. 11 is a diagram illustrating a configuration example of an AC-DC converter 14.

FIG. 12 is a diagram illustrating a configuration example of an AC-DC converter 15.

### DETAILED DESCRIPTION

At least following matters will become apparent from the descriptions of the present description and the accompanying drawings. The same or equivalent constituent elements, members, and the like illustrated in the drawings are given the same reference numerals, and repetitive description is omitted as appropriate.

### Embodiments

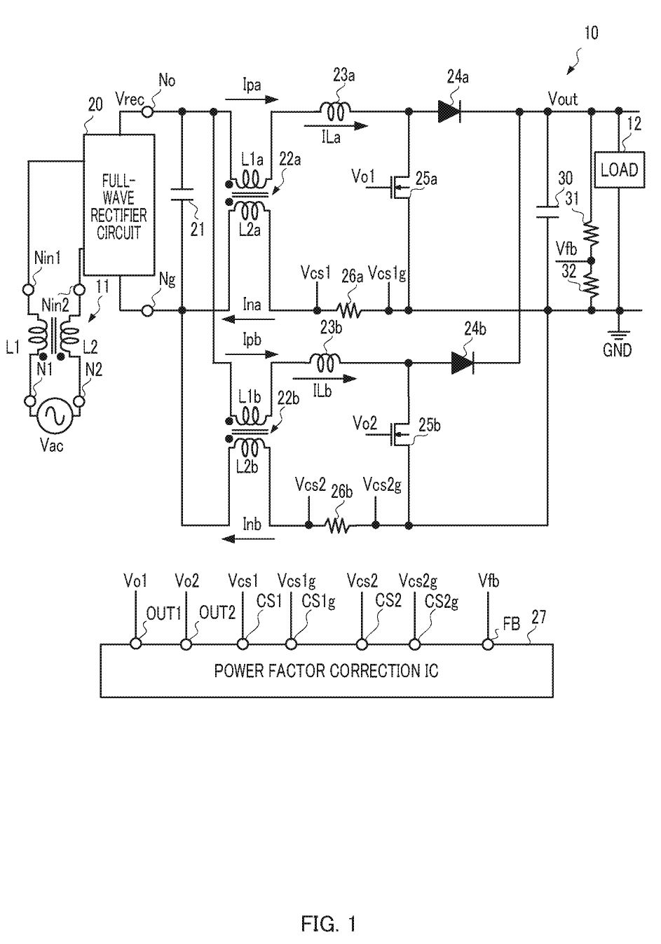

FIG. 1 is a diagram illustrating a configuration example of an AC-DC converter 10 which is an embodiment of the present disclosure. The AC-DC converter 10 is a boost chopper power supply circuit that generates an output voltage Vout of a target level from an alternating-current (AC) voltage Vac of a commercial power supply inputted thereto. Note that the AC-DC converter 10 applies the output voltage Vout to a load 12, to thereby supply power. Further, as will be described in detail below, the AC-DC converter 10 includes an N-channel metal–oxide–semiconductor (NMOS) transistors 25a, 25b (described below) that are configured to be switched to operate in an interleaved manner, and operates as a power factor correction circuit that operates in a critical mode.

The AC-DC converter 10 includes common mode chokes 11, 22a, 22b, a full-wave rectifier circuit 20, capacitors 21, 30, inductors 23a, 23b, diodes 24a, 24b, the NMOS transistors 25a, 25b, resistors 26a, 26b, 31, 32, and a power factor correction IC 27.

The common mode choke 11 prevents the noise generated by the switching of the NMOS transistors 25a, 25b (described below) from leaking out to the commercial power supply side. Further, the common mode choke 11 applies the alternating current (AC) voltage Vac with common mode noise removed, to the full-wave rectifier circuit 20 (described below). Further, the common mode choke 11 includes: a coil L1 that is connected between a node N1 to receive the AC voltage Vac, and an input node Nin1 of the full-wave rectifier circuit 20; and a coil L2 that is connected between a node N2 to receive the AC voltage Vac, and the input node Nin2 of the full-wave rectifier circuit 20. Note that the common mode choke 11 corresponds to a "third common mode choke". Further, the node N1 corresponds to a "first node", the node N2 corresponds to a "second node", the input node Nin1 corresponds to a "first input node", and the input node Nin2 corresponds to a "second input node".

The full-wave rectifier circuit 20 full-wave rectifies the AC voltage Vac with ripple component removed and outputs a full-wave rectified voltage, and applies it as a full-wave rectified voltage Vrec through the positive-side output node No of the full-wave rectifier circuit 20 to the capacitor 21 and the common mode chokes 22a, 22b. Note that the AC voltage Vac is, for example, a voltage having an effective value in a range of 140 to 240 V and a frequency in a range of 50 to 60 Hz. In an embodiment of the present disclosure, the voltages described below are each basically a difference in potential relative to a reference point (GND in FIG. 1), however, the AC voltage Vac refers to a voltage between terminals.

The capacitor 21 smooths the input voltage Vrec, and the capacitor 30 configures a boost chopper circuit together with the inductors 23a, 23b and the NMOS transistors 25a, 25b. Thus, the charge voltage of the capacitor 30 results in the direct current (DC) output voltage Vout.

The common mode chokes 22a, 22b, which will be described in detail below, prevent noise from propagating to the commercial power supply side, and causing the currents Ipa and Ipb respectively flowing from the node No to the inductors 23a and 23b, to be respectively equal to the currents Ina and Inb respectively flowing from the resistors 26a and 26b to a node Ng.

The common mode choke 22a has: a coil L1a connected between the node No and the inductor 23a; and a coil L2a connected between the negative-side output node Ng of the full-wave rectifier circuit 20 and the low-potential-side electrode of the NMOS transistor 25a. Further, the common mode choke 22a applies the full-wave rectified voltage Vrec to the inductor 23a. Furthermore, the current flowing through the coil L1a corresponds to the current Ipa, and the current flowing through the coil L2a corresponds to the current Ina.

The common mode choke 22b has: a coil L1b connected between the node No and the inductor 23b; and a coil L2b connected between the negative-side output node Ng of the full-wave rectifier circuit 20 and the low-potential-side electrode of the NMOS transistor 25b. Further, the common mode choke 22b applies the full-wave rectified voltage Vrec to the inductor 23b. Furthermore, the current flowing through the coil L1b corresponds to the current Ipb, and the current flowing through the coil L2b corresponds to the current Inb.

Note that the common mode choke 22a corresponds to a "first common mode choke", and the common mode choke 22b corresponds to a "second common mode choke". Further, the coil L1a, L1b corresponds to a "first coil", and the coil L2a, L2b corresponds to a "second coil".

The diodes 24a and 24b respectively charge the capacitor 30 with inductor currents ILa and ILb respectively corresponding to the voltages generated at the inductors 23a and 23b during the time periods during which the NMOS transistors 25a and 25b (described below) are off, respectively. As a result, the output voltage Vout is generated at the capacitor 30.

The NMOS transistors 25a and 25b are switching devices to respectively control the inductor currents ILa and ILb respectively flowing through the inductors 23a and 23b, to thereby control the power to the load 12 of the AC-DC converter 10. Note that in an embodiment of the present disclosure, the NMOS transistors 25a, 25b are n-type metal oxide semiconductor (NMOS) transistors, but they may be, for example, bipolar transistors, insulated gate bipolar transistors (IGBTs) or the like.

Further, the gate electrode of the NMOS transistor 25a is connected to a terminal OUT1 of the power factor correction IC 27, and the gate electrode of the NMOS transistor 25b is connected to a terminal OUT2 of the power factor correction IC 27. Further, the inductor 23a corresponds to a "first inductor", the inductor 23b corresponds to a "second inductor", the NMOS transistor 25a corresponds to a "first transistor", and the NMOS transistor 25b corresponds to a "second transistor". Furthermore, the inductor current ILa corresponds to a "first inductor current", and the inductor current ILb corresponds to a "second inductor current".

The resistors 26a and 26b respectively detect the inductor currents ILa and ILb respectively flowing through the NMOS transistors 25a and 25b, or the inductor currents ILa and ILb flowing through the capacitor 30. Further, voltages Vcs1 and Vcs2 respectively generated across the resistors 26a and 26b respectively according to the inductor currents ILa and ILb are respectively applied to terminals CS1 and CS2 of the power factor correction IC 27. Further, the resistor 26a is provided between the source electrode of the NMOS transistor 25a and the node Ng, and the resistor 26b is provided between the source electrode of the NMOS transistor 25b and the node Ng.

Further, as described above, the resistors 26a and 26b respectively detect the inductor currents ILa and ILb. However, if the common mode chokes 22a and 22b are not provided, the inductor currents ILa and ILb join at the capacitor 30, and then such a joined current is split according to the impedances of the ground lines respectively provided with the resistors 26a and 26b. As a result, the resistors 26a cannot detect only the inductor current ILa, and the resistors 26b cannot detect only the inductor current ILb.

Note that the method of detecting the current with a resistor being provided in series with the inductor 23a or the inductor 23b is difficult to implement directly because the voltage across the resistor 26a, 26b is 0.1 V or less, while the voltage relative to a ground potential that is the reference potential of the power factor correction IC 27 (described below) is generally around 400 V. There is also a method of using an isolation amplifier or the like, which results in being expensive.

Further, the resistor 26a corresponds to a "first resistor", the resistor 26b corresponds to a "second resistor", the source electrode of the NMOS transistor 25a corresponds to the "low-potential-side electrode of the first transistor", and the source electrode of the NMOS transistor 25b corresponds to the "low-potential-side electrode of the second transistor".

The power factor correction IC 27 is an integrated circuit that operates the NMOS transistors 25a, 25b in an interleaved manner to switch them such that the level of the output voltage Vout reaches a target level (e.g., 400 V) while improving the power factor of the AC-DC converter 10. Specifically, the power factor correction IC 27 controls the switching of the NMOS transistors 25a and 25b such that they are turned on, respectively, in response to the inductor currents Ila and ILb reach the predetermined value (for example, zero amperes), and they are turned off in response to the time period corresponding to the output voltage Vout having elapsed, respectively. Further, the power factor correction IC 27 has the terminals OUT1, OUT2, CS1, and CS2, and terminals CS1g, CS2g, and FB. Note that, in an embodiment of the present disclosure, terminals other than the terminals OUT1 and the like of the power factor correction IC 27 are omitted for convenience. Further, the power factor correction IC 27 corresponds to a "switching control circuit".

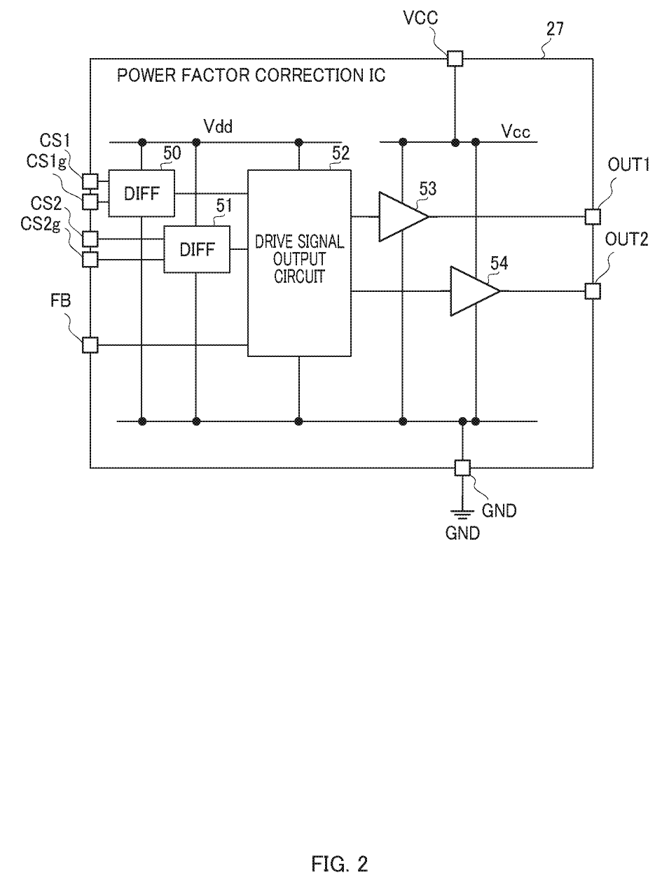

As illustrated in FIG. 2, the power factor correction IC 27 operates using the ground potential of the capacitor 30 as the reference potential, detects the respective voltages across the resistors 26a and 26b, and detects the inductor currents ILa and ILb, respectively. Further, the power factor correction IC 27 switches the NMOS transistors 25a and 25b, based on the inductor currents ILa and ILb, respectively and a feedback voltage Vfb.

The power factor correction IC 27 includes a differential amplifier circuit (DIFF) 50, 51, a drive signal output circuit 52, and driver circuits 53, 54.

The differential amplifier circuits 50 and 51 respectively detect the inductor currents ILa and ILb, based on the voltages respectively generated across the resistors 26a and 26b.

The drive signal output circuit 52 outputs drive signals to respectively drive the NMOS transistors 25a and 25b, based on the detection results of the differential amplifier circuits 50 and 51, respectively, and the feedback voltage Vfb (described below). Note that the differential amplifier circuits 50, 51 and the drive signal output circuit 52 operate based on a voltage Vdd generated internally from the power supply voltage Vcc, with the ground potential of the capacitor 30 being served as the reference potential.

The driver circuits 53 and 54 respectively amplify the drive signals from the drive signal output circuit 52, and output voltages Vo1 and Vo2, respectively, and switch the NMOS transistors 25a and 25b, respectively. The driver circuits 53 and 54 operate based on the power supply voltage Vcc, with the ground potential of the capacitor 30 being served as the reference potential.

The resistors 31, 32 in FIG. 1 configure a voltage divider circuit that divides the output voltage Vout1, to thereby generate the feedback voltage Vfb to be used in switching the NMOS transistors 25a, 25b. Note that the feedback voltage Vfb, which is generated at the node at which the resistors 31 and 32 are connected, is applied to the terminal FB.

### Operation of Common Mode Choke 22a, 22b

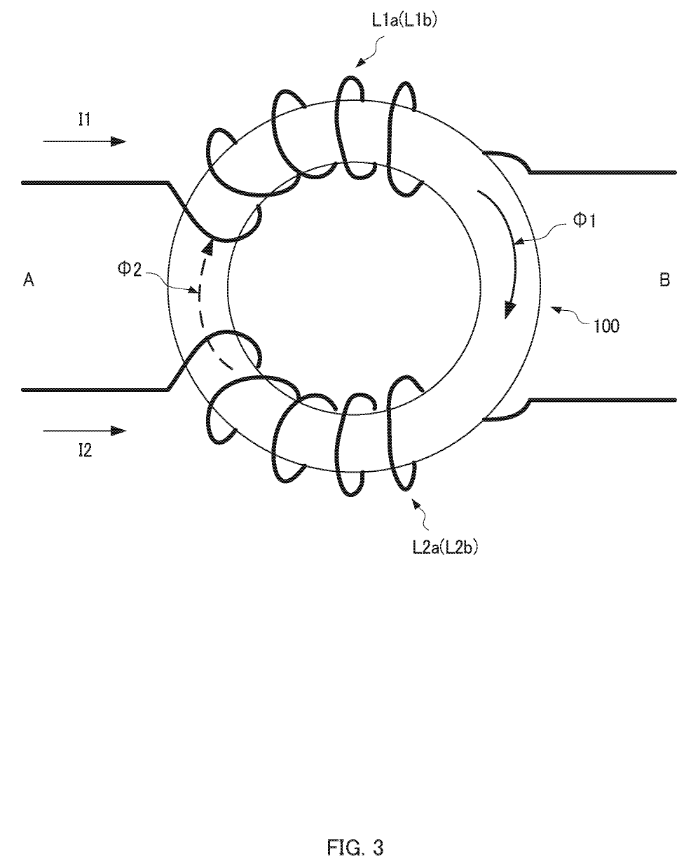

FIGS. 3 to 5 illustrate an example of the operation of the common mode choke 22a, 22b. In FIGS. 3 to 5, the positive-side output node No and the negative-side output node Ng of the full-wave rectifier circuit 20 is connected to an A-side electrode, and either the inductor 23a or 23b and either the resistor 26a or 26b is connected to a B-side electrode.

FIG. 3 is a diagram illustrating examples of magnetic fluxes Φ1 and Φ2 generated in a core 100 of the common mode choke 22a (or the common mode choke 22b) when currents I1 and I2 respectively flow from the A-side electrode to the B-side electrode through the coils L1a and L2a (or the coils L1b and L2b), respectively.

When the current I1 flows from the A side to the B side through the coil L1a, the magnetic flux Φ1 is generated within the core 100. Further, when the current I2 flows from the A side to the B side through the coil L2a, the magnetic flux Φ2 is generated within the core 100. The magnetic fluxes Φ1 and Φ2 are generated in the same direction within the core 100, and thus the magnetic fluxes within the core 100 become stronger, resulting in electromotive forces being generated across the coil L1a and L2a in a direction of opposing the currents I1 and I2, respectively. Accordingly, the currents I1, I2 flowing from the A side to the B side decrease according to the magnetic fluxes Φ1 and Φ2 generated within the core 100. This enables the common mode chokes 22a, 22b to remove the currents flowing in the same direction through the coils L1a, L2a.

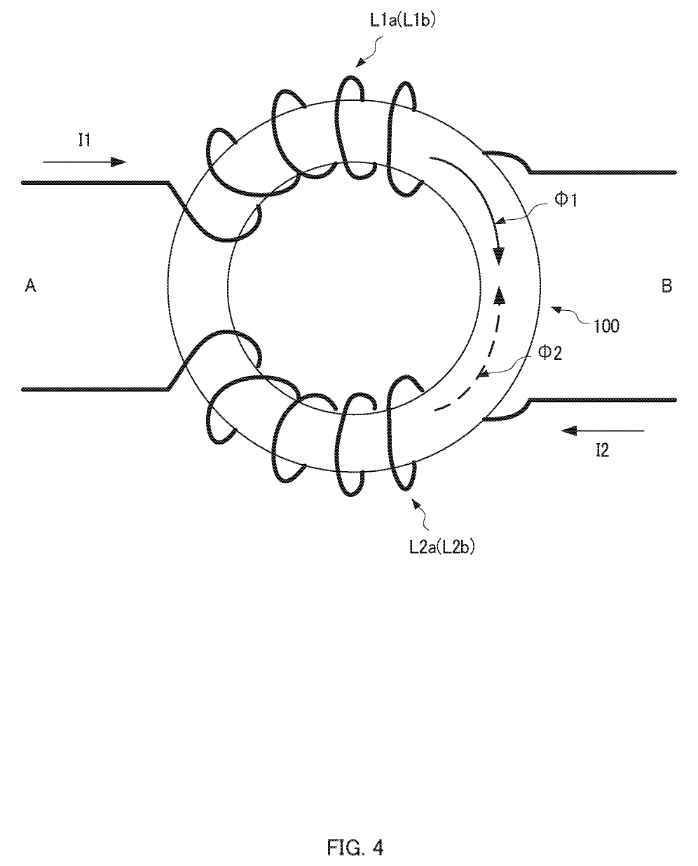

FIG. 4 is a diagram illustrating examples of the magnetic fluxes Φ1 and Φ2 generated in the core 100 of the common mode choke 22a (or the common mode choke 22b) when the current I1 flows from the A side to the B side through the coil L1a (or the coil L1b) and the current I2 flows from the B side to the A side through the coil L2a (or the coil L2b).

When the current I1 flows from the A side to the B side through the coil L1a, the magnetic flux Φ1 is generated within the core 100. Further, when the current I2 of the current value equal to that of the current I1 flows from the B side to the A side through the coil L2a, the magnetic flux Φ2 having the same magnitude as that of the magnetic flux Φ1 is generated within the core 100. Since the magnetic fluxes Φ1 and Φ2 are generated in directions opposite to each other within the core 100, the magnetic fluxes in the core 100 are cancelled. Accordingly, the currents I1, I2 are not affected because the magnetic fluxes within the core 100 are cancelled. Thus, the common mode chokes 22a, 22b do not affect the currents I1, I2 of the same current value flowing in the opposite directions through the coils L1a, L2a.

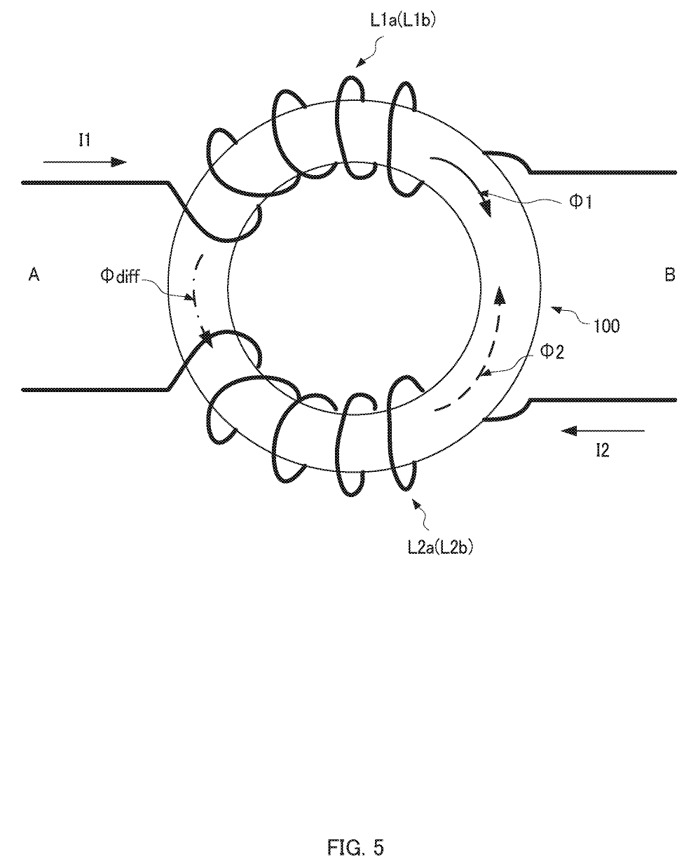

FIG. 5 is a diagram illustrating examples of the magnetic fluxes Φ1 and Φ2 generated in the core 100 of the common mode choke 22a (or the common mode choke 22b) when the current I1 flows from the A side to the B side through the coil L1a (or the coil L1b) and the current I2 flows from the B side to the A side through the coil L2a (or the coil L2b).

When the current I1 flows from the A side to the B side through the coil L1a, the magnetic flux Φ1 is generated within the core 100. Further, when the current I2 of the current value greater than that of the current I1 flows from the B side to the A side through the coil L2a, the magnetic flux Φ2 is generated within the core 100. The magnetic fluxes Φ1 and Φ2 are generated in directions opposite to each other within the core 100, and thus a magnetic flux Φdiff, which is the difference between the magnetic fluxes Φ1 and Φ2, is generated within the core 100. Since the magnetic flux Φdiff is generated within the core 100, the current I1 increases and the current I2 decreases. Accordingly, the common mode choke 22a, 22b operates such that the currents I1, I2 flowing in the directions opposite to each other through the coils L1a, L2a will have the same current value.

Accordingly, the common mode choke 22a operates such that the currents Ipa, Ina flowing in the same direction are removed and the currents Ipa and Ina flowing in different directions will have the same current value. Similarly, the common mode choke 22b operates such that the currents Ipb, Inb flowing in the same direction are removed and the currents Ipb, Inb flowing in different directions have the same current value. Thus, the currents respectively flowing through the resistors 26a and 26b will respectively match the inductor currents ILa and ILb respectively flowing through the inductors 23a and 23b of the respective boost chopper circuits. This makes it possible to provide the power supply circuit capable of detecting the timing at which the inductor current reaches the predetermined value without using an auxiliary coil.

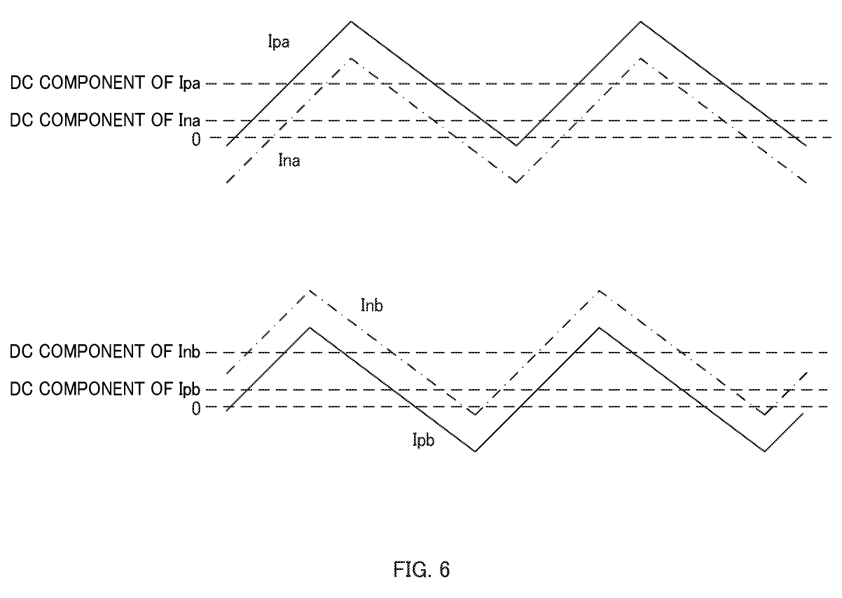

However, the common mode chokes 22a and 22b cause the inductor currents Ipa and Ina, which are AC components, to match, and cause the currents Ipb and Inb to match. Meanwhile, the electromotive forces generated across the above-mentioned coils are proportional to changes in the magnetic fluxes, and thus electromotive forces are not generated with respect to DC components that do not involve changes in the magnetic fluxes. As a result, the DC components may not match, as illustrated in FIG. 6. However, if the currents Ipa, Ina, Ipb, and Inb drop below the ground voltage, as illustrated in FIG. 6, the power factor correction IC 27 can detect that the inductor currents ILa and ILb reach the predetermined value.

### Simulation Results

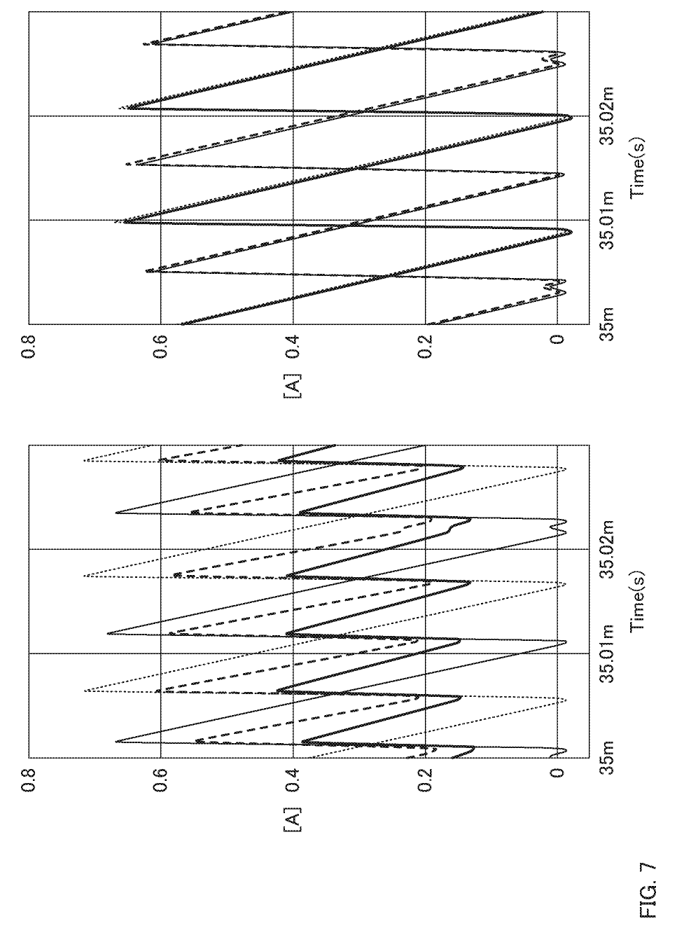

FIG. 7 is a diagram illustrating simulation results. In FIG. 7, a thin solid line indicates the current flowing through the inductor 23b, a dashed line indicates the current flowing through the resistor 26b, the dotted line indicates the current flowing through the inductor 23a, and the thick solid line indicates the current flowing through the resistor 26a. In performing simulations, in order to confirm a state including the case where the currents flowing through the resistors 26a, 26b will have waveforms that are unsuitable for control, the currents of the inductors 23a, 23b are directly detected in a manner separate therefrom, to create a simulation model to perform switching control based on the detected currents.

The simulation results on the left side of FIG. 7 are the simulation results without using the common mode chokes 22a, 22b, and the simulation results on the right side of FIG. 7 are simulation results when using the common mode chokes 22a, 22b.

In the simulation results on the left, the currents flowing through the inductor 23a and the resistor 26a do not match, and the currents flowing through the inductor 23b and the resistor 26b do not match, either.

On the other hand, in the simulation results on the right side, the AC components of the currents flowing through the inductor 23a and the resistor 26a match, and the AC components of the currents flowing through the inductor 23b and the resistor 26b also match. However, there is a slight deviation in the DC components.

As such, when the common mode chokes 22a, 22b are used, if the deviation in the DC components is ignored, it can be seen that the currents respectively flowing through the inductors 23a, 23b can be detected by resistors 26a, 26b, respectively.

Further, the following describes a modification in which the DC components are caused to substantially match, in order to detect that the inductor current ILa, ILb reaches the predetermined value.

### Modification(s)

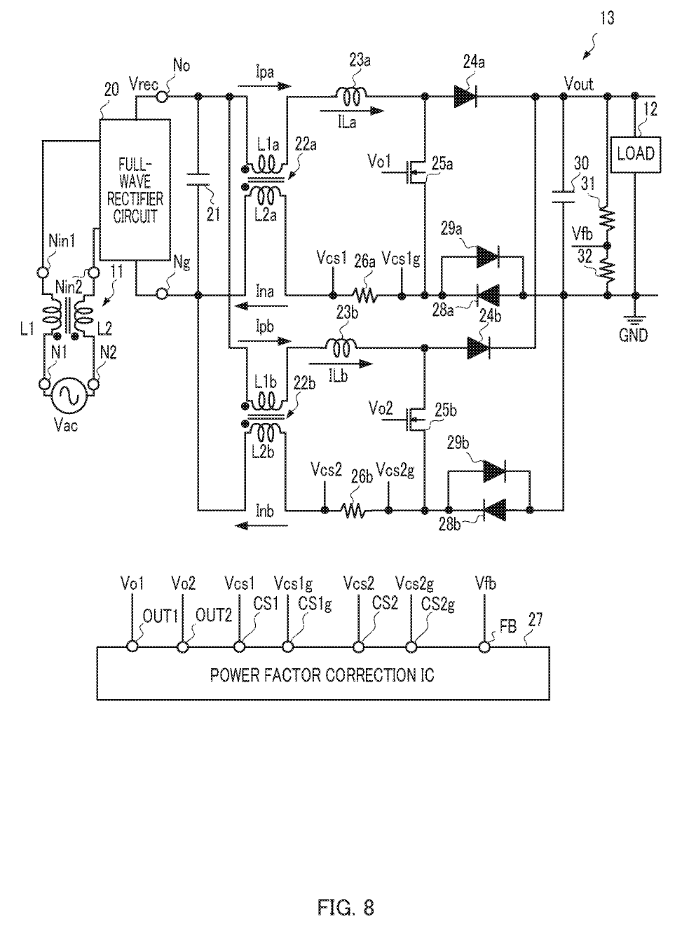

FIG. 8 is a diagram illustrating a configuration example of an AC-DC converter 13. The AC-DC converter 13 includes the common mode chokes 11, 22a, 22b, the full-wave rectifier circuit 20, the capacitors 21, 30, the inductors 23a, 23b, the diodes 24a, 24b, diodes 28a, 28b, 29a, 29b, the NMOS transistors 25a, 25b, the resistors 26a, 26b, 31, 32, and the power factor correction IC 27.

The diodes 28a and 28b are impedance elements that respectively prevent the inductor currents ILa and ILb from the respective source electrodes of the NMOS transistors 25a and 25b from flowing toward the low-potential-side electrode of the capacitor 30. Specifically, the diode 28a prevents the inductor current ILa from flowing to the low potential side of the capacitor 30 in response to the NMOS transistor 25a being turned on. Further, the diode 28a is provided between the source electrodes of the NMOS transistor electrode 25a and the low-potential-side electrode of the capacitor 30, and the diode 28b is provided between the source electrodes of the NMOS transistor electrode 25b and the low-potential-side electrode of the capacitor 30.

Further, the diode 28a has an anode connected to the low-potential-side electrode of the capacitor 30 and a cathode connected to the source electrode of the NMOS transistor 25a. Similarly, the diode 28b has an anode connected to the low-potential-electrode of the capacitor 30 and a cathode connected to the source electrode of the NMOS transistor 25b. Further, the diode 28a, 28b only has to prevent the current from running around, and thus may have a withstand voltage that is lower than that of the diode 24a, 24b.

Note that the diode 28a corresponds to a "first impedance element" and a "first diode", and the diode 28b corresponds to a "second impedance element" and a "third diode".

The diodes 29a, 29b respectively suppress fluctuations in the potentials of the source electrodes of the NMOS transistors 25a, 25b caused by the provision of the diodes 28a, 28b, respectively. Specifically, the diode 29a is turned on when the potential at the source electrode of the NMOS transistor 25a rises higher than the ground potential by an amount corresponding to the forward voltage of the diode 29a (for example, 0.3 volts), and limits the fluctuations in the potential of the source electrode of the NMOS transistor 25a to 0.3 volts, for example. The same applies to the diode 29b.

The diode 29a has an anode connected to the source electrode of the NMOS transistor 25a and a cathode connected to the low-potential-side electrode of the capacitor 30. Further, the diode 29b also has an anode connected to the source electrode of the NMOS transistor 25b and a cathode connected to the low-potential-side electrode of the capacitor 30.

Instead of the diodes 29a, 29b, a non-linear element that exhibits a higher resistance value than the impedance of the ground line with respect to a small current value and a lower resistance value with respect to a relatively large current value may be used. Further, the diode 29a corresponds to a "second diode", and the diode 29b corresponds to a "fourth diode".

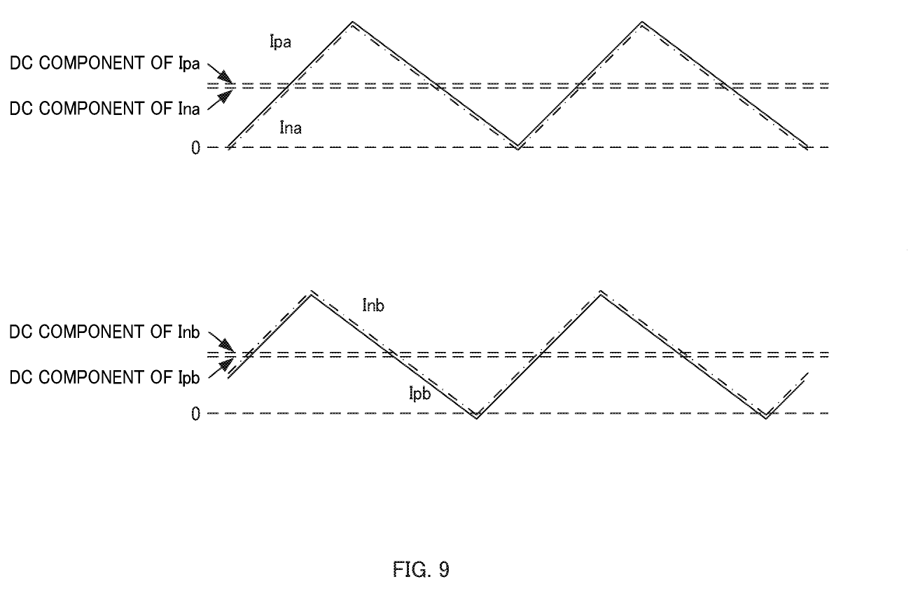

Further, with the provision of the diodes 28a, 28b, 29a, and 29b, the DC components of the currents Ipa and Ina and the DC components of the currents Ipb and Inb substantially match, as illustrated in FIG. 9, thereby being able to relatively correctly detect that the inductor currents ILa, ILb reach the predetermined value. This makes it possible to provide the power supply circuit capable of detecting the timing at which the inductor current reaches the predetermined value without using an auxiliary coil.

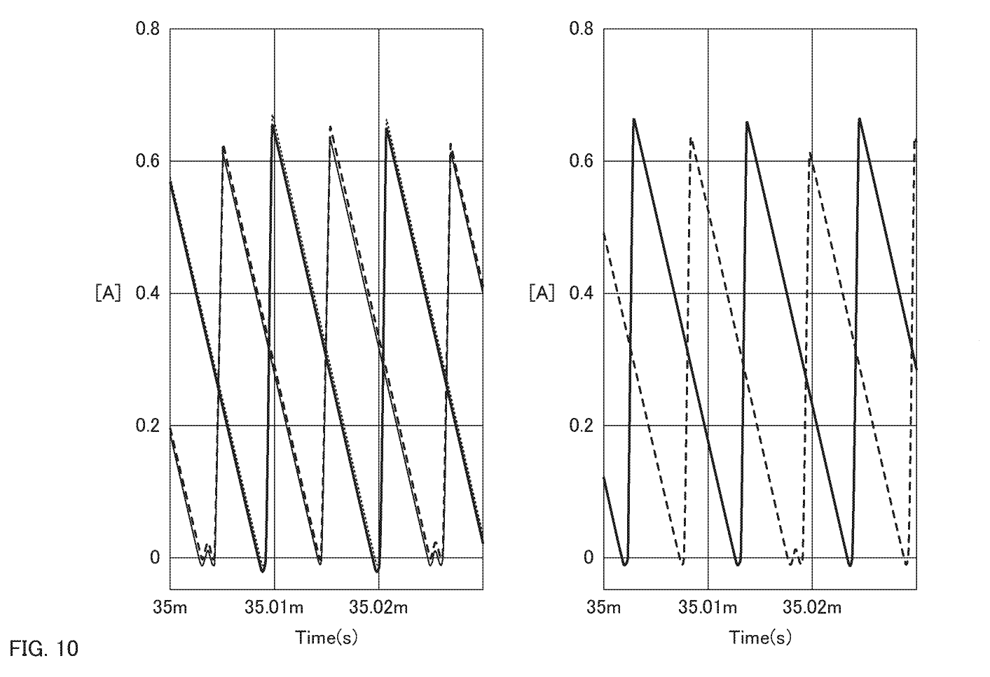

FIG. 10 is a diagram illustrating simulation results. In FIG. 10, a thin solid line indicates the current flowing through the inductor 23b, a dashed line indicates the current flowing through the resistor 26b, a dotted line indicates the current flowing through the inductor 23a, and a thick solid line indicates the current flowing through the resistor 26a. In performing simulations, in order to confirm a state including the case where the currents flowing through the resistors 26a, 26b will have waveforms that are unsuitable for control, the currents of the inductors 23a, 23b are directly detected in a manner separate therefrom, to create a simulation model to perform switching control based on the detected currents.

The simulation results on the left side of FIG. 10 are the simulation results when using the common mode chokes 22a, 22b, and the simulation results on the right side of FIG. 10 are the simulation results when using the common mode chokes 22a, 22b and the diodes 28a, 28b, 29a, and 29b.

In the simulation results on the left, the AC components of the currents flowing through the inductor 23a and the resistor 26a match, and the AC components of the currents flowing through the inductor 23b and the resistor 26b also match. However, there is a slight deviation in the DC components.

On the other hand, in the simulation results on the right side, the currents flowing through the inductor 23a and the resistor 26a match and coincide with each other, and the currents flowing through the inductor 23b and the resistor 26b also match and coincide with each other.

As such, when the common mode chokes 22a, 22b and the diodes 28a, 28b, 29a, and 29b are used, the currents respectively flowing through the inductors 23a, 23b can be detected by the resistors 26a, 26b, respectively, and it can be seen that the DC components also substantially match.

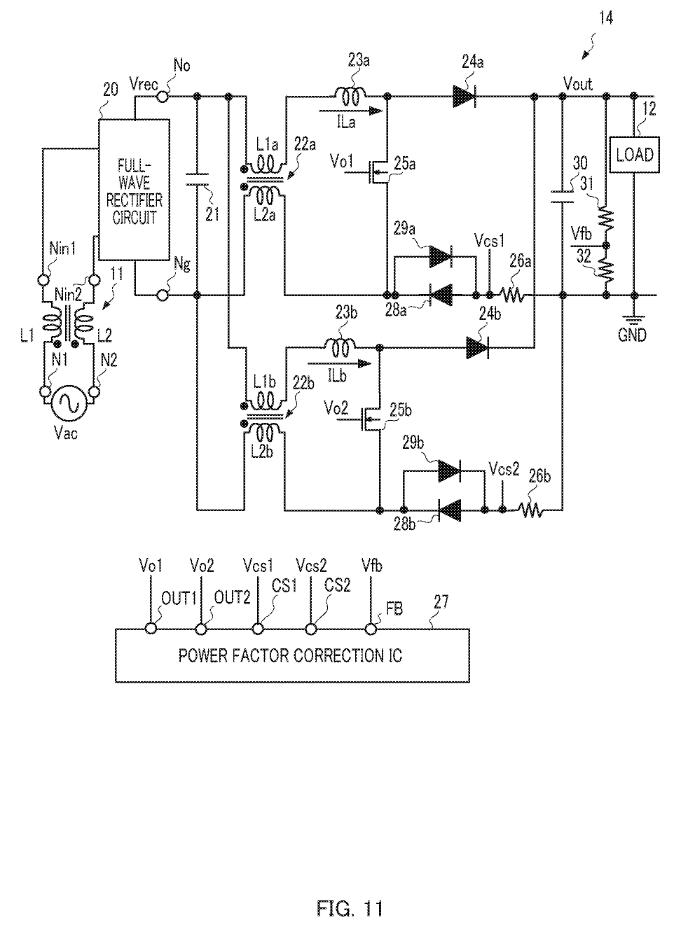

FIG. 11 is a diagram illustrating a configuration example of an AC-DC converter 14. The AC-DC converter 14 includes the common mode chokes 11, 22a, 22b, the full-wave rectifier circuit 20, the capacitors 21, 30, the inductors 23a, 23b, the diodes 24a, 24b, 28a, 28b, 29a, 29b, the NMOS transistors 25a, 25b, the resistors 26a, 26b, 31, 32, and the power factor correction IC 27.

In the AC-DC converter 14, as in the AC-DC converter 13, the diodes 28a, 28b, 29a, 29b are provided, and thus the potentials at the source electrodes of the NMOS transistors 25a, 25b are maintained at a predetermined level. Thus, even if the resistor 26a is provided between the cathode of the diode 29a and the low-potential-side electrode of the capacitor 30, and the resistor 26b is provided between the cathode of the diode 29b and the low-potential-side electrode of the capacitor 30, the inductor currents ILa, ILb can be detected when the NMOS transistors 25a, 25b are off, respectively.

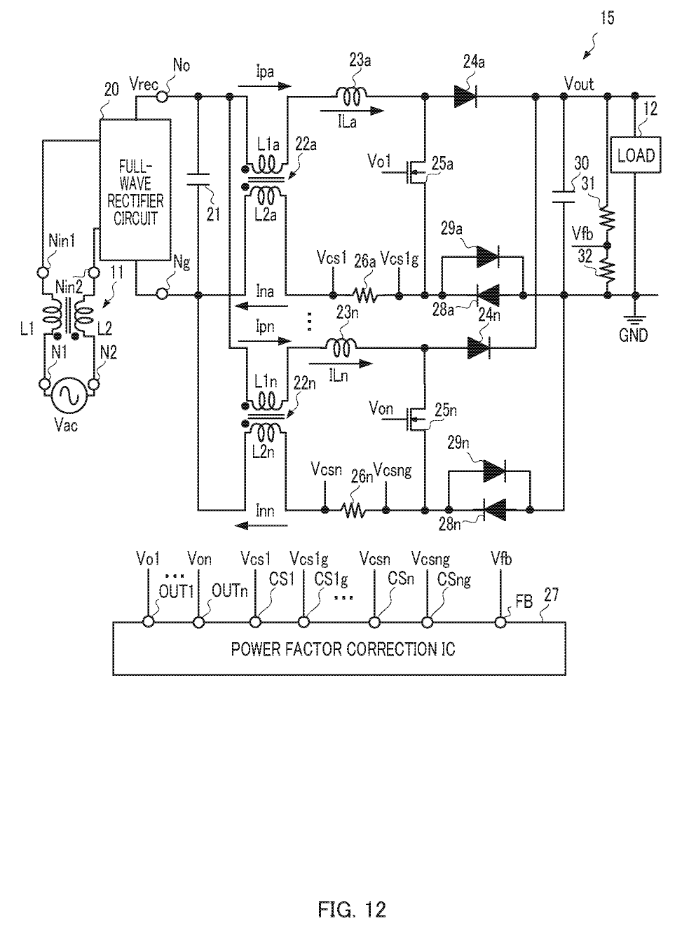

FIG. 12 is a diagram illustrating a configuration example of an AC-DC converter 15. In the AC-DC converter 15, n NMOS transistors (for example, NMOS transistors 25a to 25n) are switched so as to operate in an interleaved manner.

The AC-DC converter 15 includes the common mode choke 11, common mode chokes 22a to 22n, the full-wave rectifier circuit 20, the capacitors 21, 30, inductors 23a to 23n, diodes 24a to 24n, 28a to 28n, 29a to 29n, NMOS transistors 25a to 25n, resistors 26a to 26n, the resistors 31, 32, and the power factor correction IC 27. The operation of the elements included in the AC-DC converter 15 is the same as that of the AC-DC converter 13, and thus a description thereof is omitted.

Further, in the AC-DC converters 10, 13, 14, 15, the common mode choke (for example, common mode chokes 22a, 22b) is provided for each of the circuit groups that operate in an interleaved manner. However, since the common mode choke 22a performs control such that the inductor current ILa flows through the resistor 26a, naturally, only the inductor current ILb flows through the resistor 26b, and thus the common mode choke 22b is not necessarily needed in the AC-DC converters 10, 13, 14.

Similarly, the circuit group including the NMOS transistor 25n in the AC-DC converter 15 does not necessarily need the common mode choke 22n, as long as all other circuit groups have common mode chokes (for example, the common mode choke 22a).

Furthermore, in the AC-DC converters 10, 13, 14, 15, it is assumed that the common mode choke 11 is provided, but the common mode choke 11 is not necessarily needed as long as the common mode choke 22a and the like is provided.

### Summary

A description has been given of the AC-DC converter 10 according to an embodiment of the present disclosure. The AC-DC converter 10 includes the full-wave rectifier circuit 20, the inductors 23a, 23b, the NMOS transistors 25a, 25b, the common mode choke 22a, the resistors 26a, 26b, and the power factor correction IC 27. This makes it possible to provide the power supply circuit capable of detecting the timing at which the inductor current reaches the predetermined value without using an auxiliary coil.

Further, the AC-DC converter 10 further includes the common mode choke 22b. Since the AC-DC converter 10 includes the common mode chokes 22a, 22b, the current Ina of the current value equal to that of the inductor current ILa flows through the resistor 26a, and the current Inb of the current value equal to that of the inductor current ILb flows through resistor 26b. This makes it possible to detect, using the resistors 26a and 26b, that the inductor currents ILa and ILb reach the predetermined value, respectively, when the NMOS transistors 25a and 25b are off without using an auxiliary coil.

Further, the AC-DC converter 10 further includes the common mode choke 11. This prevents the noise generated by the switching of the NMOS transistors 25a, 25b (described below) from leaking out to the commercial power supply side.

Further, the AC-DC converter 13 further includes the capacitor 30 and the impedance element. This makes it possible to prevent the inductor current ILa from running around to the low-potential-side electrode of the capacitor 30 when the NMOS transistor 25a is on.

Further, the impedance element is the diode 28a. This makes it possible to prevent the inductor current ILa from running around to the low-potential-side electrode of the capacitor 30 when the NMOS transistor 25a is on, and to use a diode having a withstand voltage lower than that of the diode 24a as the diode 28a, which results in lower forward voltage drop, thereby being able to minimize the efficiency degradation caused by conduction losses.

Further, the AC-DC converter 13 further includes the diode 29a. This makes it possible to limit the potential of the source electrode of the NMOS transistor 25a to a potential equal to or less than the forward voltage of the diode 29a (for example, 0.3 volts).

Further, the AC-DC converter 13 further includes two impedance elements. This makes it possible to prevent the inductor currents ILa and ILb from running around to the low-potential-side electrode of the capacitor 30 when the NMOS transistors 25a and 25b are on, respectively.

Further, the two impedance elements are the diodes 28a and 28b. This makes it possible to prevent the inductor currents ILa and ILb from running around to the low-potential-side electrode of the capacitor 30 when the NMOS transistors 25a and 25b are on, respectively, and to use diodes having a withstand voltage lower than the withstand voltages(s) of the diodes 24a and 24b, as the diode 28a and 28b, which results in lower forward voltage drop, thereby being able to minimize the efficiency degradation caused by conduction losses.

Further, the AC-DC converter 13 further includes the diodes 29a and 29b. This makes it possible to limit the potentials of the respective source electrodes of the NMOS transistors 25a and 25b to potentials equal to or less than the respective forward voltages of the diodes 29a and 29b (for example, 0.3 volts).

Further, the resistor 26a is provided between the source electrode of the NMOS transistor 25a and the node Ng, and the resistor 26b is provided between the source electrode of the NMOS transistor 25a and the node Ng. This makes it possible to detect the inductor currents ILa and ILb even if the NMOS transistors 25a and 25b are either on or off, respectively. In other words, the resistors 26a and 26b can detect that the inductor currents ILa and ILb reach the predetermined value after the NMOS transistors 25a and 25b are turned off, respectively.

Further, the resistor 26a is provided between the cathode of the diode 29a and the low-potential-side electrode of the capacitor 30, and the resistor 26b is provided between the cathode of the diode 29b and the low-potential-side electrode of the capacitor 30. This makes it possible to detect the inductor currents ILa and ILb when the NMOS transistors 25a and 25b are off, respectively, and detect that the inductor currents ILa and ILb reach the predetermined value after the NMOS transistors 25a and 25b are turned off, respectively.

Further, the AC-DC converter 15 includes the full-wave rectifier circuit 20, the n inductors 23a to 23n, the n NMOS transistors 25a to 25n, the (n-1) common mode chokes 22a to 22(n-1), the n resistors 26a to 26n, and the power factor correction IC 27. Accordingly, the AC-DC converter 15 can cause the n (n is an integer of 3 or more) NMOS transistors 25a to 25n to operate in an interleaved manner.

The present disclosure is directed to provision of a power supply circuit configured to detect the timing at which an inductor current reaches a predetermined value without using an auxiliary transformer.

According to the present disclosure, it is possible to provide a power supply circuit capable of detecting the timing at which the inductor current reaches a predetermined value without using an auxiliary coil.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A power supply circuit configured to generate an output voltage at a target level from an alternating current (AC) voltage inputted thereto, the power supply circuit comprising:
a full-wave rectifier circuit configured to rectify the AC voltage and output a full-wave rectified voltage, the full-wave rectifier circuit having a positive-side output node and a negative-side output node;
a first inductor and a second conductor that are configured to receive a voltage corresponding to the full-wave rectified voltage, each of the first inductor and the second conductor having a low-potential-side electrode;
a first transistor configured to control a first inductor current flowing through the first inductor;
a second transistor configured to control a second inductor current flowing through the second inductor;
a first common mode choke including
a first coil connected between the positive-side output node of the full-wave rectifier circuit and the first inductor, and
a second coil connected between the negative-side output node of the full-wave rectifier circuit and the low-potential-side electrode of the first transistor;
a first resistor configured to detect the first inductor current;
a second resistor configured to detect the second inductor current; and
a switching control circuit configured to control switching of the first transistor and the second transistor, based on the first inductor current detected by the first resistor, the second inductor current detected by the second resistor, and the output voltage.

2. The power supply circuit according to claim 1, further comprising:
a second common mode choke including
a first coil connected between the positive-side output node of the full-wave rectifier circuit and the second inductor, and
a second coil connected between the negative-side output node of the full-wave rectifier circuit and the low-potential-side electrode of the second transistor.

3. The power supply circuit according to claim 1, wherein
the full-wave rectifier circuit further has a first input node and a second input node; and
the power supply circuit further includes a third common mode choke including
a first coil connected between
a first node configured to receive the AC voltage, and
the first input node of the full-wave rectifier circuit, and
a second coil connected between
a second node configured to receive the AC voltage, and the second input node of the full-wave rectifier circuit.

4. The power supply circuit according to claim 1, further comprising:
a capacitor configured to receive the output voltage, the capacitor having a low-potential-side electrode; and
a first impedance element provided between the low-potential-side electrode of the first transistor and the low-potential-side electrode of the capacitor.

5. The power supply circuit according to claim 4, wherein the first impedance element is a first diode having an anode connected to the low-potential-side electrode of the capacitor and a cathode connected to the low-potential-side electrode of the first transistor.

6. The power supply circuit according to claim 5, further comprising:
a second diode having an anode connected to the low-potential-side electrode of the first transistor and a cathode connected to the low-potential-side electrode of the capacitor.

7. The power supply circuit according to claim 2, further comprising:
a capacitor configured to receive the output voltage, the capacitor having a low-potential-side electrode;
a first impedance element provided between the low-potential-side electrode of the first transistor and the low-potential-side electrode of the capacitor; and
a second impedance element provided between the low-potential-side electrode of the second transistor and the low-potential-side electrode of the capacitor.

8. The power supply circuit according to claim 7, wherein
the first impedance element is a first diode having an anode connected to the low-potential-side electrode of the capacitor and a cathode connected to the low-potential-side electrode of the first transistor, and
the second impedance element is a third diode having an anode connected to the low-potential-side electrode of the capacitor and a cathode connected to the low-potential-side electrode of the second transistor.

9. The power supply circuit according to claim 8, further comprising:
a second diode having an anode connected to the low-potential-side electrode of the first transistor and a cathode connected to the low-potential-side electrode of the capacitor; and
a fourth diode having an anode connected to the low-potential-side electrode of the second transistor and a cathode connected to the low-potential-side electrode of the capacitor.

10. The power supply circuit according to claim 1, wherein
the first resistor is provided between the low-potential-side electrode of the first transistor and the negative-side output node of the full-wave rectifier circuit, and
the second resistor is provided between the low-potential-side electrode of the second transistor and the negative-side output node of the full-wave rectifier circuit.

11. The power supply circuit according to claim 9, wherein
the first resistor is provided between the cathode of the second diode and the low-potential-side electrode of the capacitor, and
the second resistor is provided between the cathode of the fourth diode and the low-potential-side electrode of the capacitor.

12. A power supply circuit configured to generate an output voltage at a target level from an alternating current (AC) voltage inputted thereto, the power supply circuit comprising:
a full-wave rectifier circuit configured to rectify the AC voltage, and output a full-wave rectified voltage, the full-wave rectifier circuit having a positive-side output node and a negative-side output node;
n inductors each configured to receive a voltage corresponding to the full-wave rectified voltage, the n being an integer of 3 or more;
n transistors configured to respectively control inductor currents flowing through the n inductors;
(n-1) common mode chokes each including
a first coil connected between the positive-side output node of the full-wave rectifier circuit and each of (n-1) inductors, and
a second coil connected between the negative-side output node of the full-wave rectifier circuit and each of low-potential-side electrodes of (n-1) transistors;
n resistors configured to respectively detect the inductor currents flowing through the n inductors; and
a switching control circuit configured to control switching of the n transistors, based on the inductor currents flowing through the n inductors detected by the n resistors, respectively, and the output voltage.
